(19) United States
(12) Patent Application Publication
(10) Pub. No.: US 2002/0017158 A1
(43) Pub. Date: Feb. 14, 2002

(54) Variable drive mechanism for bicycle and the like

(76) Inventor: Joseph R. Lemmens, Apex, NC (US)

Correspondence Address: JOSEPH R. LEMMENS, 910 S. SALEM ST., APEX, NC, 27502, US

(21) Appl. No.: 09/907,984

(22) Filed: Jul. 18, 2001

Related U.S. Application Data
(60) Provisional application No. 60/221,103, filed on Jul. 27, 2000.

(51) Int. Cl. B62M 1/02

(52) U.S. Cl. 74/594.3

(57) ABSTRACT

A variable drive mechanism for bicycle comprising a pair of input torque crank arms supported for independent rotation about a first axis and operatively connected to an output torque member rotating about a second axis. The rotary angular location of the two axes is adjustable and lockable in order to provide smoother pedaling motion or to eliminate the top dead center as is preferred with mountain bikes. With this drive mechanism, a constant speed of the output member will provide the input crank arm with a single variation of speed per revolution.

Compactness, light weight, and reliability are achieved through innovative design and geometry of components.

This application claims the benefit of U.S. Provisional Patent Application No. 60/221,103 filed Jul. 27, 2000.

The present application is also related to my U.S. Pat. No. 5,067,370 awarded on the date of Nov. 26, 1991.

### FIELD OF THE INVENTION

The present invention relates to improvements in a drive system for bicycle and similar apparatuses.

### DESCRIPTION OF THE PRIOR ART

Over the last 100 years many innovative bicycle drive systems have been patented, developed, and tried on the marketplace. Three different goals have been targeted by inventors and their inventions:

a) increase the power available

b) producing a smoother pedaling motion

c) transmitting the pedaling power more efficiently

Previous systems include some variable gear mechanisms such as eccentric lever systems in U.S. Pat. No. 657,859 awarded to J. Cottrell on Sep. 11, 1900 and more recent patents such as U.S. No. 4,793,208 of J. P. Baegnard dated Dec. 27, 1988 and U.S. No. 4,816,009 given to G. Philipp on Mar. 28, 1989. Up to now, none of these inventions have been commercialized because of the difficulties in achieving several contradicting goals simultaneously.

Bearing size of the bottom bearing hub to chain-ring spider connection is one of the weakest parts of the system since if the size of this bearing grows by one or two sizes, its width there increases by 0.050″ to 0.100″, and the weight goes up by several ounces.

Use of torque tube bearings which are lighter and more narrow does not provide any real choice since they wear out too fast and are too costly.

Total weight of some systems with gears and gear cases could increase the bike weight by three or 4 pounds which is unacceptable performance-wise.

### OBJECTS OF THE INVENTION

The general object of the present invention is to provide as bicycle drive system of the type single variation of speed per revolution and independent motion of each crank-arm which is stronger, more compact, and reliable in a lighter weight and cost than previous systems.

A second object of the present invention is to provide a variable speed drive system in which the bottom bracket hub special geometry allows an extra eccentricity gain.

A third object of the present invention is to provide a drive system which allows the use of a smaller diameter and stronger bearing as support of the chain-ring spider.

A fourth object of the present invention is to provide a drive system which is axially compact, therefore permitting the cyclist to use a similar pedaling position as currently.

Another object of the present invention is to provide a drive system which includes multiple rotary locking position of the bottom bracket hub allowing elimination of dead center for mountain bikes or permitting a smoother pedaling for road bikes.

A still further object of the present invention is to provide a variable speed drive system for bicycle and the like which can be easily retrofitted in current bicycles.

### SUMMARY OF THE INVENTION

The present invention relates to a crank system for bicycle or the like where the input pedal members and the output members are rotating upon axes that are located eccentrically which allow an independent speed variation per revolution; this invention is addressing the need of demanding and performance oriented cyclists for an improved drive which could allow them to be more efficient on a flat road and more powerful when climbing hills. The drive system includes a special bottom bracket hub, a strong support bearing for the chain-ring spider, and a multiple rotary locking system allowing the rider to choose the angular location of the speed variation.

### BRIEF DESCRIPTION OF THE DRAWINGS

In the drawings:

FIG. 1 is a schematic of crank-arm pedal variable speed.

FIG. 2 is a cut-section showing eccentricity between crank-arm and chain-ring axes.

FIG. 3 is a longitudinal section of a multi part hub of J. Lemmens Patent No. 5,067,370.

FIG. 4 and 5 are two cross sections of previous patents showing variable drive custommade frame system.

FIG. 6 is a bottom view of the bottom bracket and drive systems.

FIG. 7 is a longitudinal section of the 1^{st} embodiment of the present invention.

FIG. 8a is a side view of the drive system and chain-rings.

FIG. 8b is a side view of an alternative embodiment.

FIGS. 9a to 9f are several cut views showing angular locking of the bottom bracket hub with bolts and spacers.

FIG. 10 is a top view of the special bottom bracket hub.

FIG. 11 and 12 are bottom views of 2 locking positions.

FIG. 13 is a longitudinal cut view of an alternative embodiment of the bottom bracket hub.

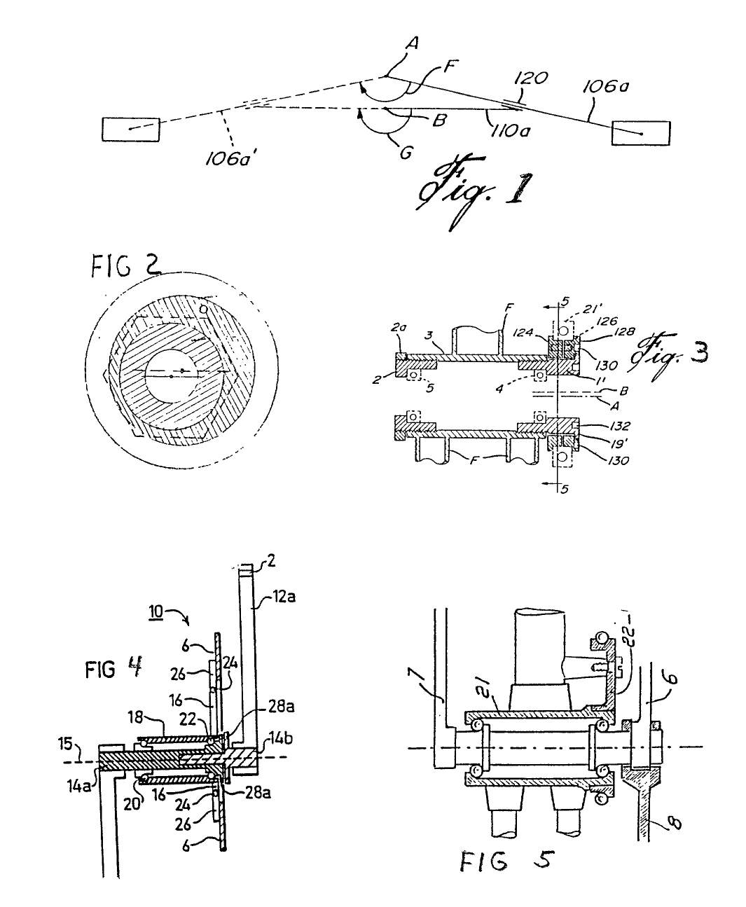

### DESCRIPTION

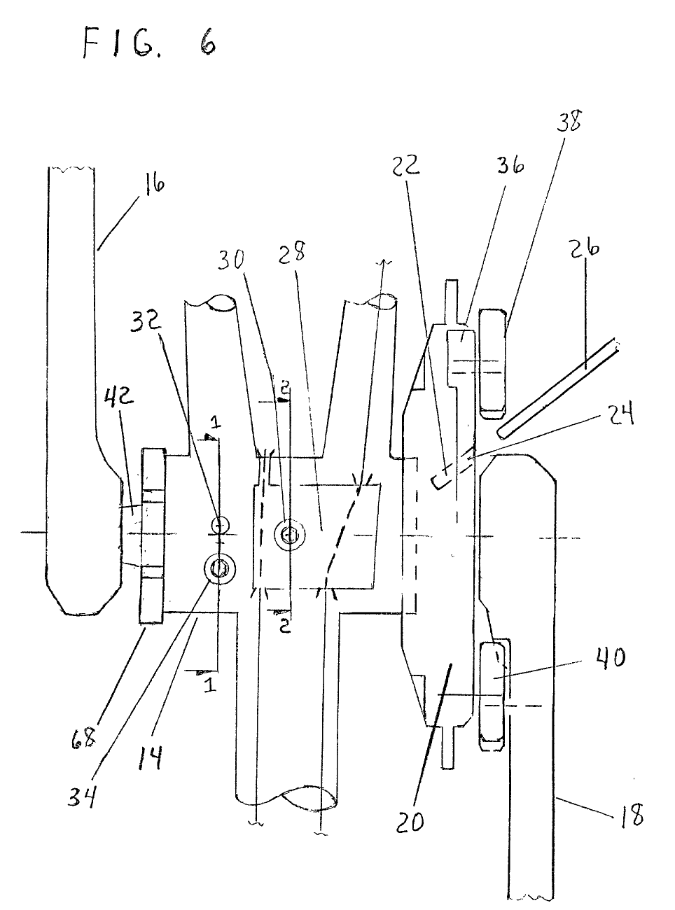

FIG. 6

The first embodiment of the present invention is shown in FIG. 6 incorporated into a bicycle bottom bracket. A bottom bracket 14 is carrying the variable drive as a standard crank set. A chain ring spider 20 and a locking nut 68 are axially locking the variable drive on each side of the bottom bracket.

A crank arm 16 is firmly secured to the square end of a spindle 42 which carries its power to a transfer arm 36. The transfer arm 36 then carries its power via a transfer arm link 38 to an eccentric rotation chain ring spider 20. A second crank arm 18 is also carrying its power via a second crank arm link 40 to the spider 20 which therefore permits independent motion and speed for each crank arm.

An adjustment hole 24 located in transfer arm 36 and a second adjustment hole 22 located in the bottom bracket hub allow angular adjustment of the crank arm variable speed. The bottom bracket 14 includes a support for derailer cable 28 secured by a bolt 3Q .A second bolt 34 is also threaded in the bottom bracket as an angular locking device which also has a second hole 32 when extra adjustment is required; a timing adjustment rod 26 allowed locking of transfer arm 36 and completes crank set 20 when angular adjustment of the eccentric hub is needed.

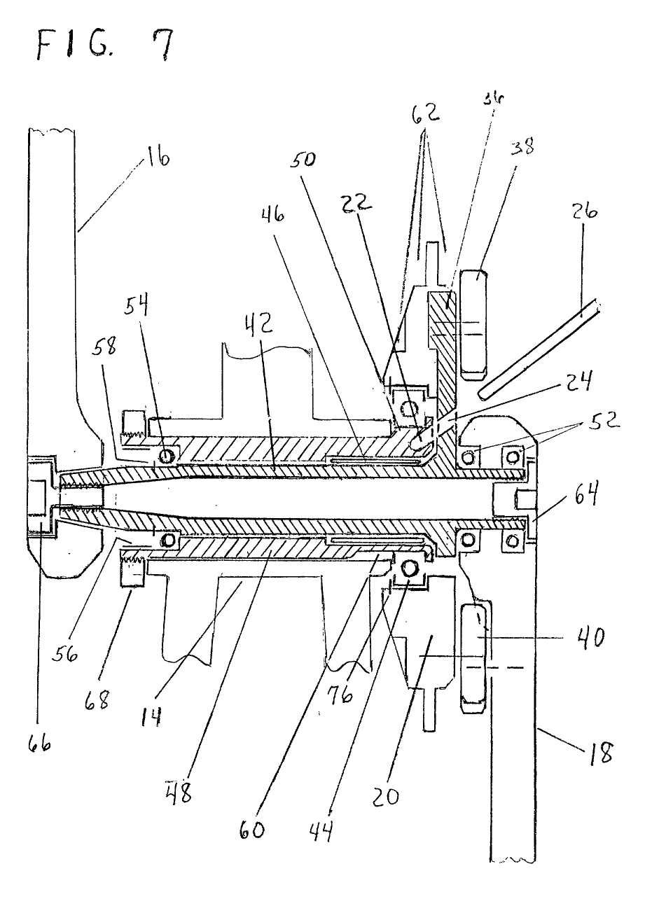

FIG. 7

Referring to FIG. 7 it is seen that the cross-sectional view of FIG. 6 will allow to understand the components structure of this first embodiment. A bottom bracket spindle 42 supports a bearing 44 which allow rotation of the chain ring spider 20. The spindle is itself supported by a needle bearing 46 at one end and by a ball bearing 54 at the other end; those 2 bearings are enclosed into a bottom bracket hub 48.

The hub 48 has a high eccentricity in area 50 and a lower wider eccentricity in area 60. The spindle 42 is carrying at one end a bearing 52 at one side of the crank arm 18 and a second bearing 52 at the other side; the crank arm 18 is also secured axially by a bolt 64. At the other end the spindle 42 is axially secured by a retaining clip 58 against bearing 54.

The bearing 54 holds axially the spindle 42 at its outer diameter by a press fit retaining ring 56; while crank arm 16 is secured axially by a bolt 66 and standard square taper configuration of mating surfaces. A double or triple chain ring sprocket attachment surface is provided in 62.

FIG. 8a

FIG. 8a is a side view of FIG. 6 showing the bottom bracket seat tube 10 having the spindle bolt 64 centrally located in the bottom bracket with axe of rotation 104. The spider 20 is located eccentrically to the bottom bracket because of eccentric hub 48 and bearing 44 not seen and rotated around axe 102. The spider gives the classic 5 attachment location to one or two or three chain-sprockets 98; the spider also carries two anchor links bolts 106 symmetrically located at 180 degrees of each other and generally under a same radius from the spider axe of rotation. Transfer arm links 40 and 38 provide strong positioning but variable speed to crank arm 18 on one part and crank arm 16 via transfer arm 36 and spindle 42 for this second power member.

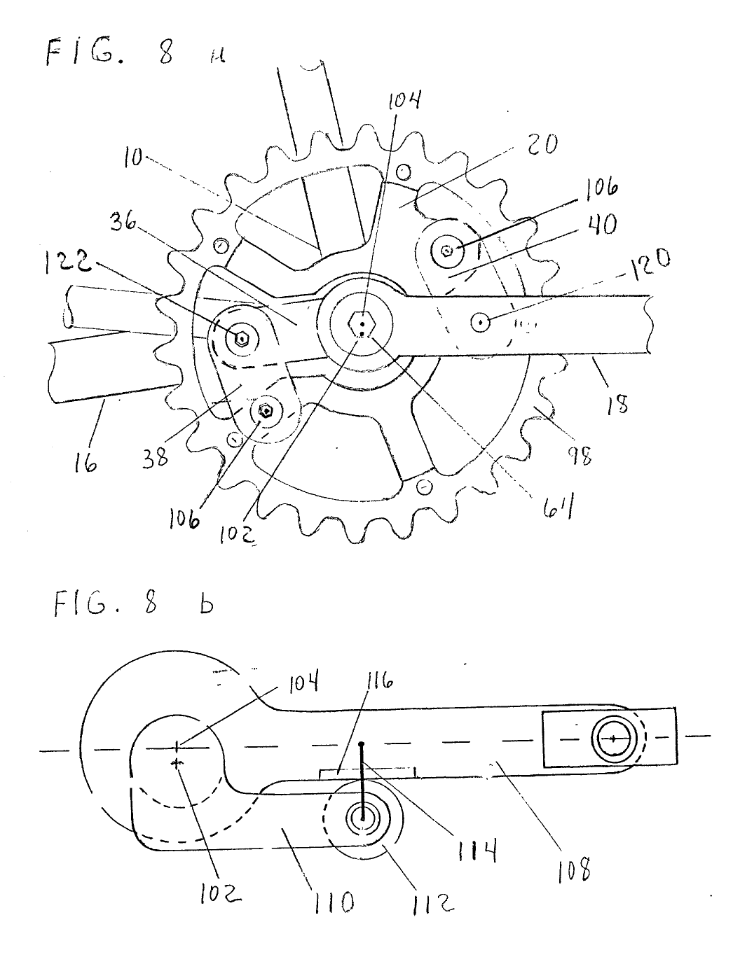

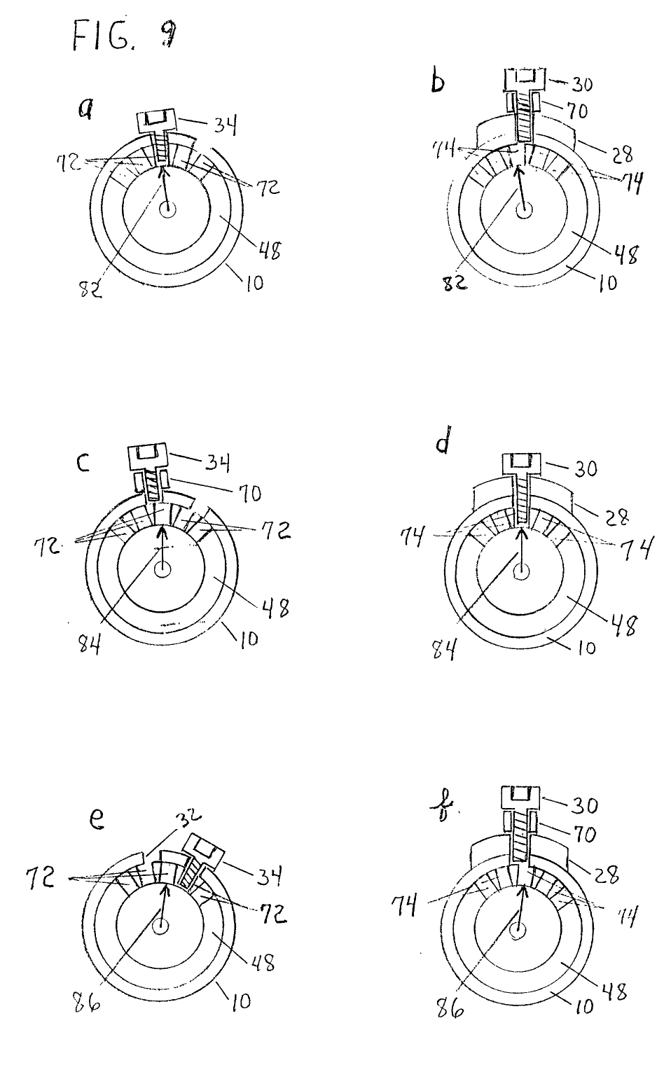

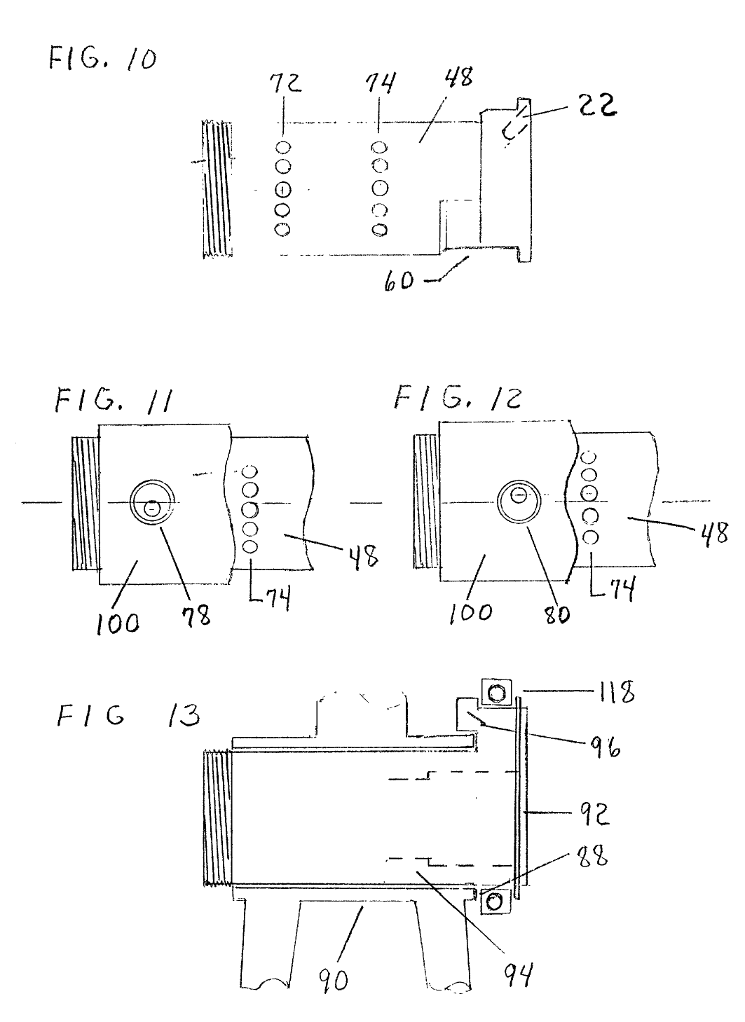

FIGS. 9 and 10

FIG. 9 and 10 are providing precise detail of the angular adjustment mechanism which is part of the first embodiment of the present invention where FIGS. 9a, c and e are cross-sections taken along line 1-1, and FIGS. 9b, d and f are also cross-sections taken along line 2-2.

FIG. 10 is a top view of the bottom bracket hub shown as a single component.

The angular adjustment of the eccentric hub 48 and its locking by bolt 30 or 34 is shown in FIG. 9a where the bolt 34 is locking the hub 48 from rotating because of its engagement in hole 72 of hub 48; during same positioning in FIG. 9b, the bolt 30 is holding the supports 28 via a spacer 70 and threaded in bottom bracket 10.

In the FIG. 9c and d where the hub 48 has been rotated 7.5°, the locking bolt 30 is now installed without the spacer in order to engage the hole 74 while bolt 34 is used with the spacer 70 in order to prevent damage to the hub holes not aligned underneath it.

Similarly, the FIG. 9e and f show a same spacer-bolts configuration as FIG. a+b however bolt 34 is more to its second hole choice in order to engage the hub hole which provides another 7.5° of adjustment.

An angular arrow shown as 82 moves from FIG. 9a and b into an angular arrow as 84 in FIG. 9c and d and later on as another angular arrow 86 in FIG. 9e and f.

Both FIG. 9 and 10 would give only a capability of 4 adjustments over a space of 90° with a single locking bolt; however the present invention showed a 3 lockings system acting alternatively and allowing to reduce each step adjustment from:

90°÷4=22.5° to 90°÷(4*3)=7.5°

### Fabrication

The fabrication of the variable crank drive for bicycle and the like is mostly centered around the crank arm spindle 42; the spindle as shown in FIG. 7 can be cast through the process of lost wax or even forged if large production was done.

Several types of alloy steel such as 8620, 4340, etc. can be used; after casting and annealing the part would be machined to near final dimension using current machine shop practice, then the part will be heat treated, tempered and receive a light grinding operation where the needle and ball bearing are supported and other required contact area. To insure proper life the hardness should be over 55 R.C. since the needle bearing rolls directly on the spindle surface. The bottom bracket at transfer arm could also be built of two parts. In such case, the spindle will have an increase in diameter near the transfer arm location. A 1/10″ thick by 1 inch diameter circle will be followed by a square shape ¾″ by ¾″ of ⅚″ to ⅜ of width, the transfer arm in this case 7075 T6 or higher grade assembled by press fit with interference of 0.002″.

The bottom bracket hub could be made from high strength aluminum, preferably 7075 T6. This part will therefore be machined cost effectively with a modern automatic lathe both for the inner and outer surface and threaded end; the only milling operation being the eccentric end adjusting hole which is usually done by a jig holding the part for the milling or drilling operation. Equally made of high strength 7075 T6 is the locking nut 68 which when fit on the crank set will require either permanent nylon or liquid thread locker in order to prevent loosening action during pedaling. Two other parts made of 7075 T6 bar are the transfer arm links 38 and 40 which are about 5/16 inch thick by 2¼″ long and 1¼″ wide; these links carry either needle bearings or ball bearing with O.D. of approximately ¾″ to ⅞″ and are machined following current mass production technique. The chain ring spider would preferably be made by investment casting with either A-356, A-380 or other high strength aluminum material; these castings would then receive both lathe operation and mostly C.N.C. milling work in order to achieve an elegant spider configuration allowing the part to rotate eccentrically to the crank spindle but to rotate securely the chain ring sprocket such as seen on currently produced crank set and FIG. 8a.

Other main component, the two crank arm, are currently produced from aluminum which includes casting for the lower price to forging and even machining any production of this variable crank drive would surely subcontract the crank arm to current manufacturers either in Asia, Japan or Europe.

Finish, coating and assembly of the crank set could vary greatly depending on the market it addresses. Alternative components such as double bearing in between the hub and spider is possible because of the great compactness of such bearing(only about 70 thousandths of an inch wider).

Five areas of low rotational speed with very few degrees of rotation at the transfer links connection and the chain-ring side spindle crank arm connection could benefit from alternative bearings such as Teflon composite sleeve or other advanced bearing surface with low friction and high psi capability.

### Operation

Operation, as it is well known in the group of invention on variable crank drives which date as far back as 1896, independent motion of the two cranks but same variation of speed over the same part of the rotation is achieved by rotation the chain-ring spider upon a different axe of rotation than the crank arms or the transfer arm, since it is advantageous to locate all of the special components of the variable drive near the chan-ring side.

As is shown in J. R. Lemmens Patent No. 5,067,370 and FIG. 1 of Prior Art the chain-ring in B rotate on angle G of 180° while the crank arm 106a rotates on angle F of 155° (because of his eccentric point of rotation being in A). Similarly, the current drawing FIG. 8a is showing a similar configuration.

However, with five to eight holes 72 and 74 in the hub 48, any cyclist could choose its own best variation of speed timing either fast on back pedaling like most Patents showed or with the fast portion on the upper stroke like I prefer after testing many prototypes over the last 12 years both in touring and also in racing.

Installation of the crankset will require the cyclist or mechanic to know the inner diameter of the bottom bracket which is usually 1.335 inch for the SAE system using 1.375 inch thread and approximately 1.380 for the metric using 36 mm or around 1.410 inch.

For retrofit installation, an expandable reamer will allow cleaning of the bottom bracket I.D. and precision fit of the new variable crank drive assembly. Other mechanical preparation will be the drilling of 2 extra holes in the bottom bracket with size and thread of approximately 3/16 inch 32 thread; precise location of those holes following a template will give the angular adjustment capability of 7 to 8 degrees per step.

Evidently, the derailer cable support bolt would be released during reaming and fitting of the variable crank drive assembly.

Adjusting rod 26 and instruction will allow quick angular adjustment, locking with the proper bottom bracket bolt, securing the second bolt, fastening the locking nut 68 against the bottom bracket and therefore fastening the bottom bracket hub solidly using any of the two crank anns as opposing levers to the special wrench fastening the nut 68 up to the instructed torque.

Assembly of the crank arm 16 can be done before or after tightening nut 68.

### Description

A second embodiment of the present invention showed an alternative configuration in FIG. 8b where a similar spindle hub bearing design is used but a simplified transfer power used a roller cam bearing 112 abutting against crank arm 108 which has a hardened insert 116 to prevent deformation. A spring medium 114 is keeping the component together. This configuration is providing the same advantage of speed variation as the first embodiment practically replacing the 2 transfer arms 38 and 40, plus their 4 bearings by 2 roller cams.

The second embodiment should not be restricted to FIG. 8b but should include reversing the attachment point where the 2 roller cams would be fixed to the crank arm 18 threaded into hole 120 with the cam going into contact with an abutting surface of chain-ring spider 20. Similarly, transfer arm 36 could also be installed with a roller cam into this threaded hole 122 with the cam going into contact with a symmetrically located abutting surface in chain-ring spider 20.

### Description

A third embodiment of the present invention is shown in FIG. 11 where the eccentric hub adjustment design has only one extra hole in the bottom bracket instead of 2 holes as described in the first embodiment. The single hole 78 of around 7/16 to ½ inch in diameter is not threaded but allows the insertion of a thick ⅛″ eccentric washer which when rotated 180° gives a second adjustment 80; the third adjustment is still provided by the derailer cable support bolt. This alternative design allows the new hole to be drilled in line with the 1^{st} one but requires threaded holes 72 in the eccentric hub.

There should not be any difficulty for fabrication or operation of this specific embodiment.

### Description

A fourth embodiment of the present invention is shown in the FIG. 13 where an eccentric hub 94 is allowed to be very compact with high eccentricity due to an ingenious design using part of the bicycle bottom bracket 88 as an abutment for the bearing and an overhanging support edge 96. This bearing configuration permits extra eccentricity with minimal or no penalty of width since the bearing is held externally by a retaining ring 92.

Fabrication of this alternative hub should not give any difficulties since bearing width is known and bottom groove of overhanging edge to external retaining ring should be equal to bearing width. This hub should also include an adjustment hole in its high eccentricity similarly as hub 22. Operation is same as hub 48.

While a few embodiments of the invention have been shown and described, it is to be clearly understood that the invention is not to be limited to the exact construction illustrated and described.

For example, the hub spider single-row bearing could be replaced by a double-row ball bearing of a very compact size. Similarly, the bolts and spacer locking system could easily use the alternative form of lateral teeth on the chain-rings side of the frame bottom bracket with corresponding teeth as part of the hub eccentric edge. Also, the material that is used to build the part could be interchanged from steel to other metals such as aluminum or even titanium. The processes of fabrication of the parts may also be interchanged readily.

Therefore, many alterations are possible in the practice of this invention without departing from the spirit of scope thereof. Accordingly, the scope of the invention is to be construed in accordance with the substance defined by the following claims.

I claim:

1. A variable drive for bicycle comprising:
A bottom bracket hub support, a pair of oppositely-directed input torque crank arms supported by said support, for rotation about a first axis independently of each other, an output torque wheel rotatably carried by the eccentric portion of said hub support, for rotation about a second axis spaced from and parallel to said first axis, torque transferring linkage means connecting each crank arm to a said output torque spider wheel, and means to adjustably lock said hub support so as to adjust the angular plane containing said two axes.

2. A variable drive system as defined in claim 1 further including a special hub support eccentric section so as to provide extra eccentricity.

3. A variable drive system as defined in claim 1 wherein the hub support included an eccentric bearing fitting clearance.

4. A variable drive system as defined in claim 2 further including a rotatably adjusting mean.

5. A variable drive system as defined in claim 4 wherein an adjustment rod permits timing adjustment through support hub and transfer arm holes.

6. A variable drive system as defined in claim 2 wherein the hub support included an eccentric bearing fitting clearance.

7. A variable drive system as defined in claim 1 wherein the locking mean included at least one locking bolt.

8. A variable drive system as defined in claim 2 wherein the locking mean included the locking mean included at least one locking bolt.

9. A variable drive system as defined in claim 2 wherein the hub to spider bearing is held axially on the support hub by an external retaining ring.

10. A variable drive system as defined in claim 4 further including radial locking bolt and axial hub locking nut.
